(19) United States
(12) Patent Application Publication
(10) Pub. No.: US 2009/0090699 A1
(43) Pub. Date: Apr. 9, 2009

(54) System and Method for Electroslag Welding Spliced Vertical Columns

(76) Inventor: William L. Bong, Walnut Creek, CA (US)

Correspondence Address: LAW OFFICES OF CHARLES L. THOEMING;BIELEN, LAMPE & THOEMING, P.A., TWO CORPORATE CENTRE 1390 WILLOW PASS ROAD, SUITE 1020, CONCORD, CA, 94520, US

(21) Appl. No.: 12/212,019

(22) Filed: Sep. 17, 2008

Related U.S. Application Data
(60) Provisional application No. 60/977,438, filed on Oct. 4, 2007.

(51) Int. Cl. B23K 9/18; B23K 9/12

(52) U.S. Cl. 219/73.1; 219/125.12; 219/158; 219/137 R

(57) ABSTRACT

A system and method for welding spliced vertical columns with an electroslag welding system. The system includes a welding fixture having opposing, paired and positionally adjustable welding shoes, run-off tabs, and sumps affixed at the junction of columns to be spliced. A distributed control electroslag welding system, welding torch, and consumable guide tube oscillator feed provide molten flux within the shoes filling from the sump to the run-off tab.

### CROSS-REFERENCES TO RELATED APPLICATIONS

This U.S. non-provisional patent application is based upon and claims the filing date of U.S. provisional patent application Ser. No. 60/977,438 filed Oct. 4, 2007.

### STATEMENT REGARDING FEDERALLY SPONSORED RESEARCH OR DEVELOPMENT

None.

### REFERENCE TO A MICRO-FICHE APPENDIX

None.

### TECHNICAL FIELD

This invention relates to welding. More particularly, the invention is related to a system and method for electroslag welding vertically aligned workpieces, in particular spliced vertical columns.

### BACKGROUND OF THE INVENTION

My U.S. Pat. No. 6,297,472, issued Oct. 2, 2001, discloses and claims a welding system and method including a distributed welding control system that allows a welding operator to program automated welding cycles for various welding operations, and which is particularly useful for installing stiffener plates onto structural beams. In U.S. Pat. No. 6,297,472, the welding system includes a welding fixture with a pair of opposing, positionally adjustable welding shoes, and lock screws for attaching a workpiece such as an I-beam. A rotary straight wire feeder removes the cant and helix from welding wire as it is fed to the welding torch. The welding torch is attached to the power cables coming from the welding power supply and is a receptacle for the consumable guide tube. Wire feed conduits are attached to the wire feeder on one end and the welding torch on the other. During the welding operation, welding wire is feed from the wire feeder, through the wire feed conduits to the welding torch. The wire then travels through the welding torch to the consumable guide tube and is attached to the output of the welding torch. The consumable guide tube and the welding wire carry the welding current to the molten weld puddle at the bottom of the weld cavity.

My U.S. patent application Ser. No. 10/731,414, filed Dec. 9, 2003 and related U.S. Pat. No. 7,429,716, discloses and claims a modular welding system for performing quick, easy and high quality welds. The modular welding system of application Ser. No. 10/731,414, and related U.S. Pat. No. 7,429,716 issued Sep. 30, 2008, includes a basic component system and a modular fixture component system. The basic component system provides the basic components necessary to perform a quality weld efficiently.

The modular component system interfaces with the basic component system and provides a particular welding fixture assembly that performs a particular type of weld. More particularly, a stiffener type modular component system and a butt/tee type modular system fixture system are disclosed and claimed. The modular welding system of application Ser. No. 10/731,414, and related U.S. Pat. No. 7,429,716, easily may be integrated with the basic components of the system and method for electroslag welding spliced vertical columns for high-rise building fabrication and erection.

My U.S. Pat. No. 7,038,159, issued May 2, 2006, discloses and claims a system and method for electroslag butt-welding expansion joint rails comprising a distributed welding control system. The method includes defining a weld cavity with a first expansion joint rail, a second expansion joint rail, a plurality of gland shoes, and a pair of butt shoes, and can be adapted for welding an expansion joint rail to a support beam. The system and method of U.S. Pat. No. 7,038,159 easily may be integrated with the basic components of the system and method for electroslag welding spliced vertical columns for high-rise building fabrication and erection.

My U.S. Pat. No. 7,148,443, issued Dec. 12, 2006, discloses and claims a consumable guide tube including a thin first elongate strip, a second elongated strip, and a plurality of insulators. An embodiment of U.S. Pat. No. 7,148,443 includes a thin first elongate strip that is a low carbon cold-rolled steel strip, and a second elongated strip which is a low carbon hot-rolled steel strip. The guide tube of U.S. Pat. No. 7,148,443 can also be configured to include two or more longitudinal channels, and easily is adaptable to the system and method for electroslag welding spliced vertical columns for high-rise building fabrication and erection.

My U.S. patent application Ser. No. 11/591,190, filed Oct. 30, 2006, discloses and claims a consumable guide tube including a thin first elongate strip, a second elongated strip, and a plurality of insulator modules. An embodiment of application Ser. No. 11/591,190 includes a thin first elongate strip that has a front face and a back face. The front face has at least one longitudinal channel. The second elongated strip has is a front face and a back face and the front face is of the second elongated strip is configured to be coupled to the front face of the thin first elongated strip. The plurality of insulator modules are deposited on the back face of the thin first elongated strip and on the back face of the second elongated strip. Preferably, the thin first elongated strip is a low carbon cold rolled steel strip, and the second elongated strip is a low carbon hot rolled steel strip. The guide tube of application Ser. No. 11/591,190 can also be configured to include two or more longitudinal channels. The guide tube of U.S. patent application Ser. No. 11/591,190 can also be configured to include two or more longitudinal channels, and easily is adaptable to the system and method for electroslag welding spliced vertical columns for high-rise building fabrication and erection.

The following disclosure provides a system and method for electroslag welding vertically aligned work-pieces for structures with unlimited multiple floor levels, in particular spliced vertical columns. An embodiment includes a distributed control system having a plurality of controller modules and a common bus connecting each controller module. Each controller module includes at least one operator control panel module. The system includes at least one welding torch configured to receive at least one consumable guide tube that is placed into the welding cavity. The welding torch is coupled to the welding fixture adjacent to each centerline. The system also includes first and second elongated, parallel rotating shafts according to U.S. Pat. No. 7,148,443 and pending U.S. Non-provisional Utility patent application Ser. No. 11/202,020, which are herein incorporated; first and second linear actuators according to U.S. Pat. No. 7,148,443 and pending U.S. Non-provisional Utility patent application Ser. No. 10/731,414 and related U.S. Pat. No. 7,429,716, which are herein incorporated. These actuators are movably mounted on the rotating shafts and include an assembly for longitudinally translating the linear actuators along the shafts as the shafts rotate according to U.S. Pat. No. 7,148,443 and pending U.S. Non-provisional Utility patent application Ser. No. 10/731,414 and related U.S. Pat. No. 7,429,716, which are herein incorporated. The system also includes an assembly for sensing movement of the linear actuators according to U.S. Pat. No. 7,148,443 and pending U.S. Non-provisional Utility patent application Ser. No. 10/731,414 and related U.S. Pat. No. 7,429,716, which are herein incorporated, and a protective housing assembly for enclosing the rotating shafts, the actuators, the longitudinally translating assembly, and the sensing assembly, for oscillating each welding torch with the cavity.

The welding system and method including a distributed welding control system allows the combination and use of features of my several above cited patents and/or patent applications, as more particularly incorporated and described herein, to allow a welding operator to program automated welding cycles for various welding operations, and is particularly useful for splicing vertical aligned structural columns for high-rise building fabrication and erection having an acute angle gap between the columns flanges. A disclosed embodiment of the welding system and method includes a forty-five degree angle gap between the spliced columns for high-rise building fabrication and erection.

### DISCLOSURE OF INVENTION

On-site erection of buildings is accomplished by stacking one vertical support column on top of another and welding the two stacked columns together. The bottom column flanges are cut square, and the web is generally beveled, FIGS. 6 and 7. The column that is stacked on top of the bottom column has the bottom of the flanges beveled at a 45-degree angle to provide a welding surface to connect the two columns.

For buildings with unlimited multiple floor levels, the generally accepted practice for welding the top of the bottom column flange to the bottom of the top flange is a 30-degree, 45-degree, or 60 degree bevel, FIGS. 6 and 7. When the top column is set on top of the bottom column, splice plates are generally bolted to the two webs to hold the columns together so the installation crane can be removed. The column is generally squared with cables and weld passes are made between the two column flanges and the two column webs to join the two column flanges together.

The thicker the column flanges, the more weld passes that are needed to join the two column flanges and column webs together. For flanges that are two inches thick, 8 to 16 man-hours are necessary to generate the number of weld passes to join each column flange and column web together, or a total of 16 to 34 man-hours per column.

The system and method for electroslag welding spliced vertical columns allows welding of both columns simultaneously. The typical welding time takes approximately thirty minutes. This rapid welding system and method can result in a building being welded much faster, allowing for completion and occupancy of the building in a much shorter time period than using the multi-pass FCAW, flux cored wire welding processes.

The system and method for electroslag welding spliced vertical columns is equally applicable to box-beam column architecture for buildings with unlimited multiple floor levels.

Other features, advantages, and objects of the system and method for electroslag welding spliced vertical columns will become apparent with reference to the following description and accompanying drawings.

These together with other objects of the system and method for electroslag welding spliced vertical columns, along with the various features of novelty that characterize the invention, are described with particularity in the claims attached to and forming a part of this disclosure. For a better understanding of the system and method for electroslag welding spliced vertical columns, its operating advantages and the specific objects attained by its uses, reference should be made to the attached drawings and descriptive materials in which there are illustrated preferred embodiments of the invention.

### BRIEF DESCRIPTION OF DRAWINGS

These and other features, aspects, and advantages of the system and method for electroslag welding spliced vertical columns will become better understood with regard to the following description, appended claims, and accompanying drawings as further described.

FIG. 1 is a perspective view of apparatus for a system of electroslag welding for buildings with unlimited multiple floor levels up, wherein one pair of opposing welding shoes are placed on each side of a gap between one first vertically aligned workpiece and at least one second vertically aligned workpiece to form at least one welding cavity between the welding shoes.

FIG. 2 is a perspective view of a plurality vertically aligned spliced flange workpieces, used in buildings with up to thirty (30) floors, with a forty-five degree angled gap between each separate vertically aligned sliced flange workpiece and releasable couplings which hold the spliced flange workpiece assembly together during the welding process.

FIG. 3 is a perspective view of electroslag welded spliced flange workpieces, used in buildings with unlimited multiple floor levels, conjoined along the forty-five degree angled gap.

FIG. 4 is a side view of vertically aligned spliced flange workpieces, used in buildings with unlimited multiple floor levels, depicting a forty-five degree angled gap between each separate vertically aligned spliced flange workpiece and releasable couplings holding the splice flange workpiece assembly together.

FIG. 5 is a top view of a typical vertical column placement array for each floor in a high-rise building having a substantially 320 foot side square dimension.

FIG. 6 a front view of prior art method of splicing vertical column flanges.

FIG. 7 is a side view of FIG. 6.

### BEST MODE FOR CARRYING OUT THE INVENTION

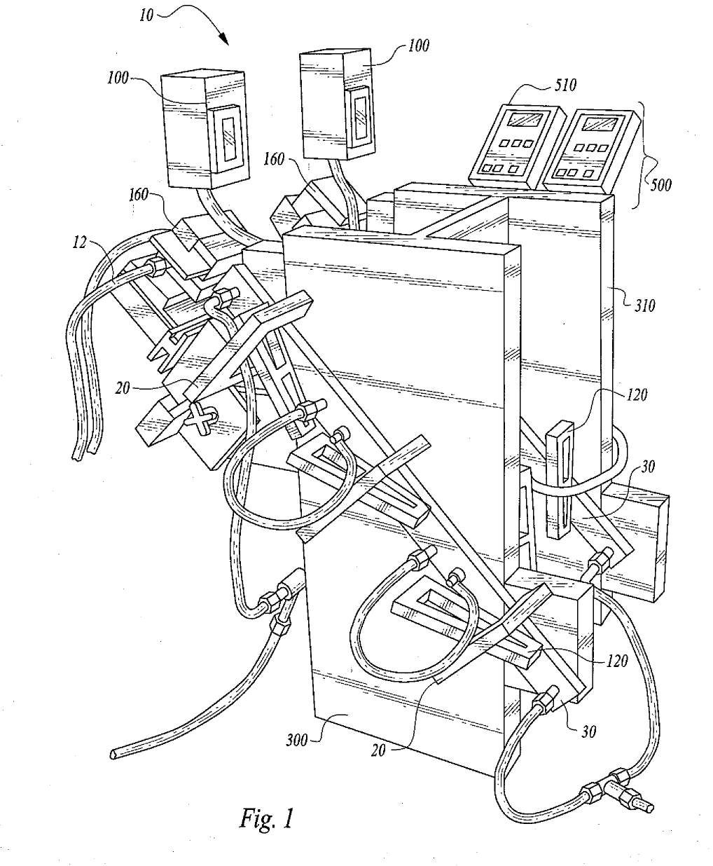

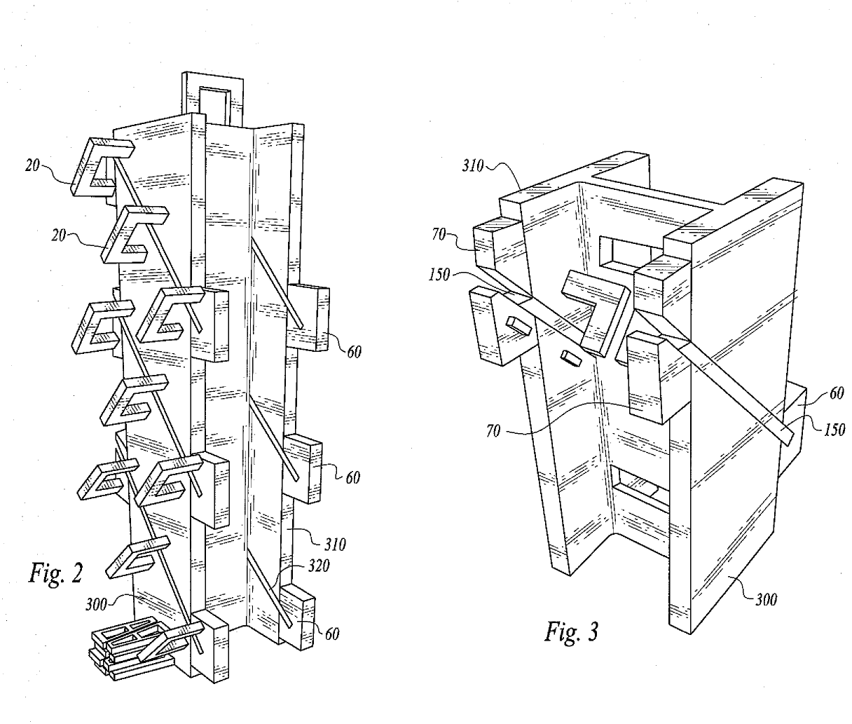

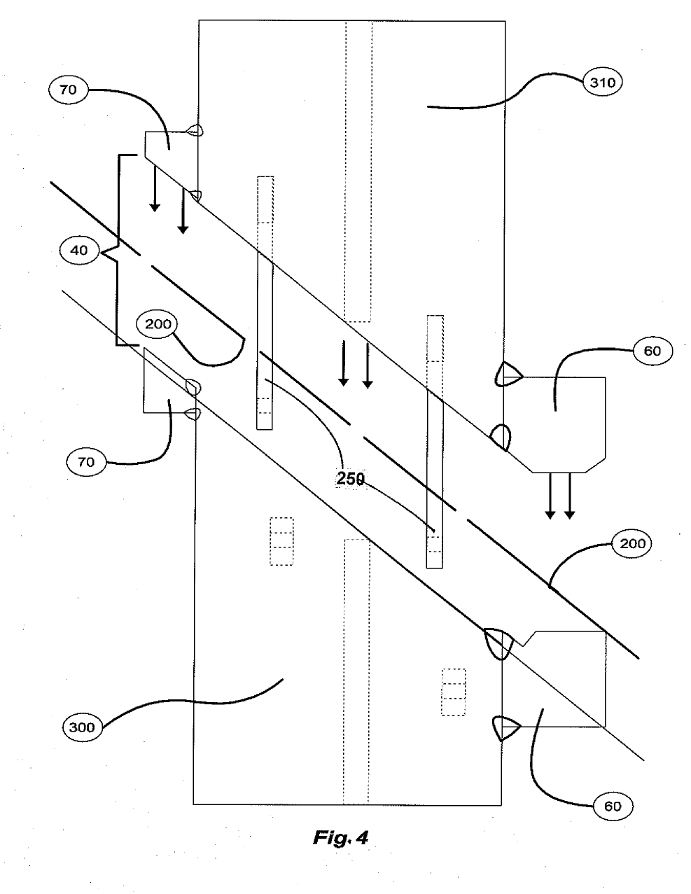

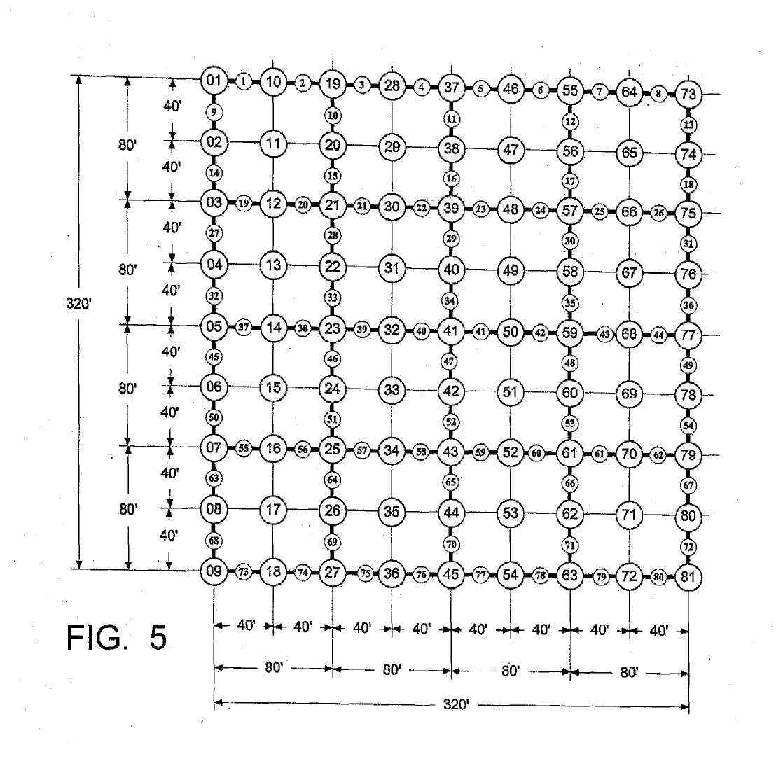

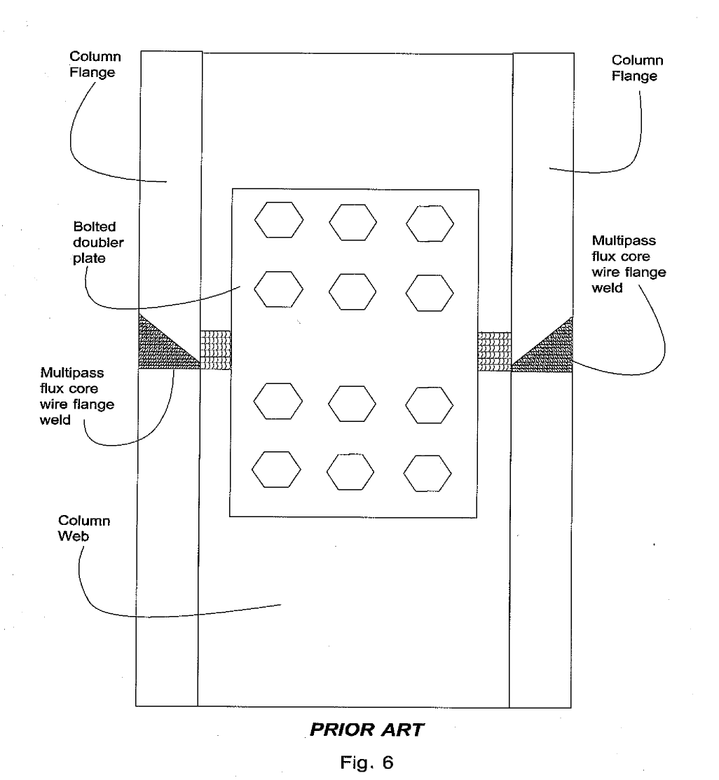

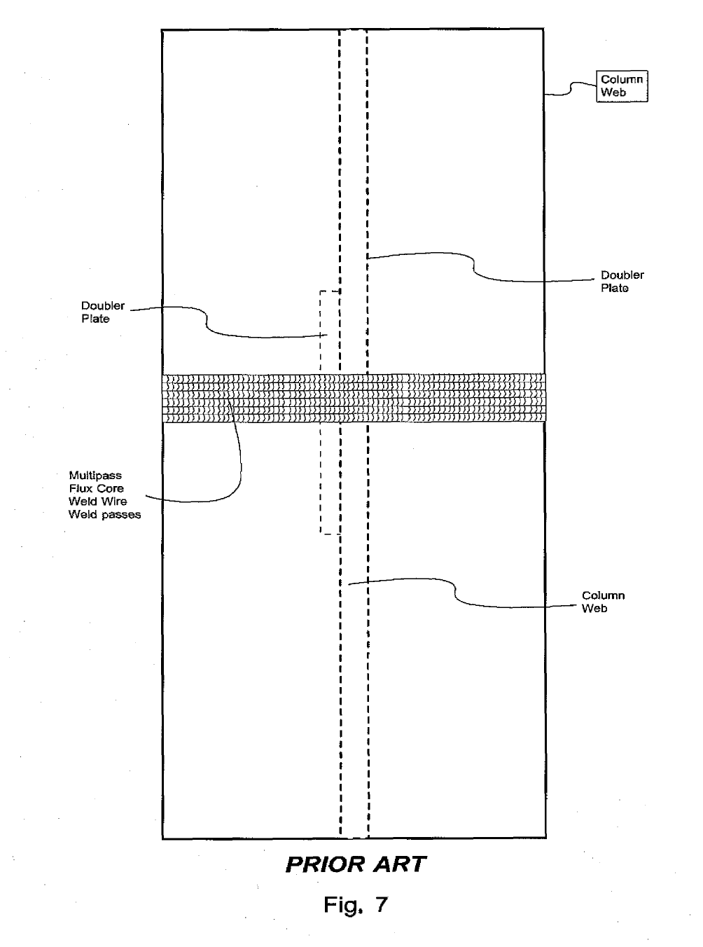

Referring more specifically to the drawings, for illustrative purposes the electroslag welding system and method used in buildings with unlimited multiple floor levels is embodied generally in FIGS. 1-5. The entire length of the spliced columns is not shown for clarity. Instead, only the spliced column ends are depicted, as it will be recognized by those skilled in the art that each spliced column between the bottom floor and the top floor includes at least two spliced sections.

It also will be appreciated that the system may vary as to configuration and as to the details of the parts, and that the method of using the system may vary as to details and to the order of steps, without departing from the basic concepts as disclosed herein. The system and method for electroslag welding are disclosed generally in terms of welding vertical columns, as this particular type of welding operation is widely used. However, the disclosed system and method may be used in a large variety of welding applications, as will be readily apparent to those skilled in the art.

Referring now to FIGS. 1-5, a welding system 10 in which at least one first vertically aligned workpiece 300 end of a first I-beam column and at least one second vertically aligned workpiece 310 end of a second I-beam column are brought together so that a gap 320 exists between each pair of workpieces is disclosed. The system 10 includes at least one stationary welding fixture 12 positioned 20 to releasably couple with at least one workpiece. The fixture further includes at least one pair of opposing welding shoes 30 which are placed on each side of each gap 320 to form at least one welding cavity 40 having a centerline between the paired workpieces, 300 and 310, and the welding shoes 30. As such, the welding fixture 12 is thus configured to symmetrically position the welding shoes 30 about the welding cavity centerline such that each pair of welding shoes 30 has a bottom portion and a top portion relative to the gap 320.

An embodiment includes welding shoes 30 which further comprise a thermally and electrically insulating coating

Each pair of vertical workpieces, 300 and 310, to be spliced comprise means for vertical alignment 250 of the pair until the welding process has been completed.

A welding torch 60 is configured to receive at least one consumable guide tube 70 which is placed into the welding cavity 40. The welding torch 60 is coupled to the welding fixture adjacent to each centerline and is connected to apparatus means for oscillating the welding torch about the centerline 200 within each cavity 40.

An embodiment of the system provides a gap 320 oriented at a forty-five degree angle between paired vertical workpieces, 300 and 310.

Another embodiment of the system further comprises at least one portable platform to carry two wire feeders, each capable of feeding at least 2-to-4 welding wires. This platform carries the welding wire for the welding operation. The portable platform has provisions for accepting the cable assemblies for providing welding power to the welding torch and consumable guide tube. This assembly is capable of moving from column to column to perform the welding operation.

Yet another embodiment of the system further comprises at least one or more welding wires (not shown). The welding wire contains proper mechanical and chemical properties capable of making welds with sufficient mechanical properties to pass any and all the applicable welding codes required for the columns being welded.

A further embodiment of the system comprises a flux dispensing means (not shown), according to U.S. Pat. No. 7,148,443 and pending U.S. Non-provisional Utility patent application Ser. No. 11/202,020, which are herein incorporated, for providing flux to a welding site adjacent each welding torch.

Another embodiment of the system includes copper welding shoes 30 that further comprise the proper thermal and electrical cooling properties sufficient to complete the weld without losing the molten weld puddle, at least one sump 60 located at the bottom of the weld cavity, and at least one set of run-off tab 70 adjacent to the top portion of each welding cavity. Each pair of welding shoes comprises copper having means for temperature control of the shoes. The welding shoe pair 30 may be air-cooled or water-cooled shoes. Opposable pairs of copper shoes are located on either side of weld cavity to retain the molten puddle during the welding operation.

An embodiment of the system comprises at least one distributed control system 500. Each distributed control system 500 comprises a plurality of controller modules 510 and a common bus connecting each of the plurality of controller modules 510, wherein each controller module 510 comprises at least one operator control panel module.

The preferred embodiment of a welding system, in which at least one pair of vertically aligned workpieces, 300 and 310 are brought together so that a forty-five degree angled gap 320 having a gap center line exists between the workpieces, 300 and 310, comprises: (a) at least one stationary welding fixture 12, each fixture comprising means for releasably coupling 20 to at least one workpiece, one or more pairs of opposing welding shoes 30 placed on each side of the gap 320 to form a welding cavity 40 between the workpieces the shoes, and means for symmetrically positioning the welding shoes 12 adjacent the cavity 40; (b) at least one welding torch 160 configured to receive at least one consumable guide tube placed into the welding cavity 40, the welding torch coupled to the welding fixture 12 adjacent to each center line; and (c) apparatus comprising: first and second elongated, hardened parallel shafts driven by a rotating threaded shaft (not shown) according to U.S. Pat. No. 7,148,443 and pending U.S. Non-provisional Utility patent application Ser. No. 11/202,020, which are herein incorporated; first and second linear actuators (not shown), the actuators movably mounted on the hardened shafts, driven by a rotating threaded shaft; means for longitudinally translating the linear actuators along the shafts as the threaded shaft rotates (not shown) according to U.S. Pat. No. 7,148,443 and pending U.S. Non-provisional Utility patent application Ser. No. 11/202,020, which are herein incorporated; first and second linear actuators (not shown) according to U.S. Pat. No. 7,148,443 and pending U.S. Non-provisional Utility patent application Ser. No. 11/202,020, which are herein incorporated; first and second linear actuators (not shown) according to U.S. Pat. No. 7,148,443 and pending U.S. Non-provisional Utility patent application Ser. No. 11/202,020, which are herein incorporated; first and second linear actuators (not shown); means for sensing movement of the linear actuators (not shown) according to U.S. Pat. No. 7,148,443 and pending U.S. Non-provisional Utility patent application Ser. No. 11/202,020, which are herein incorporated; first and second linear actuators (not shown); and protective housing means (not shown) for enclosing the rotating shafts, the actuators, the longitudinally translating means, and the sensing means, for oscillating each welding torch with the cavity.

An embodiment includes a distributed control system that includes an oscillator controller module, a wire feed controller module, and a welding power supply controller module.

The preferred embodiment welding system further comprises at least one flux dispenser 100, each flux dispenser comprising: a hopper (not shown) according to U.S. Pat. No. 7,148,443 and pending U.S. Non-provisional Utility patent application Ser. No. 11/202,020, which are herein incorporated; a rotating geared wheel positioned below the hopper according to U.S. Pat. No. 7,148,443 and pending U.S. Non-provisional Utility patent application Ser. No. 11/202,020, which are herein incorporated (not shown); a belt block (not shown) according to U.S. Pat. No. 7,148,443 and pending U.S. Non-provisional Utility patent application Ser. No. 11/202,020, which are herein incorporated having a recessed area housing the geared wheel; and at least one drop tube (not shown) associated with a lower portion of the recessed area.

The preferred embodiment welding system 10 further comprises at least one welding shoe bottom clamping assembly 120, each clamping assembly 120 comprising: first and second pairs of welding shoes 30; assembly for positionally adjusting the first pair of welding shoes relative to each other; assembly for positionally adjusting the second pair of welding shoes relative to each other; and assembly for positionally adjusting the first pair of welding shoes relatively to the second pair of welding shoes.

The preferred embodiment welding system further comprises a distributed control system 500, the distributed control system includes a plurality of control modules, at least one of the control modules having an operator control module with a bus connecting the plurality of control modules, FIG. 1. The distributed control system 500 further comprises programming controller modules 510 for carrying out the operations of: 1) reading control parameter inputs from a user, the control parameters including welding arc voltage, welding arc current, oscillator motion, and welding wire feed rate; 2) controlling welding arc voltage during an automated weld cycle; 3) controlling welding arc current during the automated weld cycle; 4) controlling oscillator motion of the welding torch during the automated weld cycle; 5) controlling flux dispensing in response to the welding arc voltage and the welding arc current during the automated weld cycle; and 6) controlling welding wire feed rate during the automated weld cycle. The distributed control system further includes an oscillator controller module, a wire feed controller module, and a welding power supply controller module.

The method of electroslag welding at least two vertical metal substrates, 300 and 310, having inside and outside surfaces used in buildings with unlimited multiple floor levels comprises the steps of:
providing a welding fixture 12, the welding fixture being stationary and including means for releasably coupling to at least one vertical metal substrate, the welding fixture including at least one pair of opposing welding shoes 30, means for symmetrically positioning the welding shoes about a center to line, a welding torch 160, and a consumable guide tube adjacent to the center line;
positioning first and second vertical metal substrates, 300 and 310, adjacent to each other, one above the other, with a gap 320 between the first and second substrates;
attaching the welding fixture to at least one of the vertical metal substrates, the welding fixture 12 positioned with the center line located adjacent the gap 320 between the substrates, 300 and 310;
positionally adjusting the opposing welding shoes 30 of the welding fixture 12 relative to the center line to define a welding cavity 40 between the welding shoes 30 and the substrates, 300 and 310, the guide tube and the center line positioned within the welding cavity 40; and
filling the welding cavity 40 with molten metal, using the VertaSlag™ welding process, to form a weld 150 connecting the substrates, 300 and 310.

The method of electroslag welding at least two vertical metal substrates, 300 and 310, having inside and outside surfaces used in buildings with unlimited multiple floor levels further comprises the steps of:
feeding welding wire through the welding torch and consumable guide tube; and
oscillating the consumable guide tube and the welding wire within the weld cavity.

For this method of electroslag welding at least two vertical metal substrates, 300 and 310, having inside and outside surfaces for use in buildings with unlimited multiple floor levels, the first substrate 300 comprises a vertically aligned I-beam column having a top surface angled 45 degrees to a horizontal plane perpendicular to the first substrate alignment and the second substrate 310 comprises a vertically aligned I-beam column having a bottom surface angled 45 degrees to a horizontal plane perpendicular to the second substrate alignment, such that the first substrate top surface and the second substrate bottom surface define the gap 320 between the substrates, 300 and 310.

The method of electroslag welding at least two vertical metal substrates, 300 and 310, having inside and outside surfaces useful in buildings with unlimited multiple floor levels, further comprises the step of:
providing at least one welded strongback 250 connecting the substrate inside and outside surfaces.

The method of electroslag welding at least two vertical metal substrates having inside and outside surfaces useful in buildings with unlimited multiple floor levels, further comprises the step of:
attaching a welding shoe clamping assembly 120 to the connected substrates, 300 and 310, the welding shoe clamping assembly 120 including: first and second pairs of welding shoes 30; assembly for positionally adjusting the first pair of welding shoes relative to each other; assembly for positionally adjusting the second pair of welding shoes relative to each other; and assembly for positionally adjusting the first pair of welding shoes relatively to the second pair of welding shoes.

A more detailed description of the control system is provided in U.S. Pat. No. 7,038,159 and pending U.S. Non-provisional Utility patent application Ser. No. 10/731,414 and related U.S. Pat. No. 7,429,716, which both are hereby incorporated by reference.

Referring more specifically to the drawings, for illustrative purposes the electroslag welding system and method used in taller buildings with unlimited multiple floor levels is embodied generally in FIGS. 1-5. It will be appreciated that the system may vary as to configuration and as to the details of the parts, and that the method of using the system may vary as to details and to the order of steps, without departing from the basic concepts as disclosed herein. The system and method for electroslag welding are disclosed generally in terms of welding vertical columns, as this particular type of welding operation is widely used. However, the disclosed system and method may be used in a large variety of welding applications, as will be readily apparent to those skilled in the art.

I claim:

1. A welding system in which at least one first vertically aligned workpiece and at least one second vertically aligned workpiece are brought together so that a gap exists between the pair of vertically aligned workpieces, the system comprising:
(a) at least one welding fixture positioned to releasably couple with at least one of the vertically aligned workpieces, the fixture further comprising at least one pair of opposing welding shoes which are placed on each side of each gap to form at least one welding cavity having a center line between each of the paired vertically aligned workpieces and the welding shoes, the welding fixture configured to position the welding shoes about the welding cavity center line such that each pair of welding shoes have a bottom portion and a top portion relative to the gap;
(b) a welding torch configured to receive at least one consumable guide tube which is placed into the welding cavity, the welding torch coupled to the welding fixture adjacent to each center line; and
(c) means for oscillating the welding torch about the center line within each cavity.

2. The system of claim 1, wherein the gap is oriented at a forty-five degree angle between each of the paired vertically aligned workpieces.

3. The system of claim 1, further comprising at least one-movable portable platform to carry the wire feeders and welding-wire from building column to column, and using the wire feeder to pull wire from the wire source and push the wire down a flexible conduit assemblies to the welding torch assembly, down the consumable guide tube to the welding puddle.

4. The system of claim 1, further comprising at least one welding wire.

5. The system of claim 1, further comprising flux dispensing means for providing flux to a welding site adjacent each welding torch.

6. The system of claim 1, wherein the welding shoes further comprise a thermally and electrically insulating coating.

7. The system of claim 1, further comprising at least one distributed control system, each distributed control system comprising a plurality of controller modules and a common bus connecting each of the plurality of controller modules, wherein each controller module comprises at least one operator control panel module.

8. The system of claim 1, wherein each pair of welding shoes comprises at least one sump adjacent to the bottom portion.

9. The system of claim 1, wherein each pair of welding shoes comprises at least one run-off tab adjacent to the top portion.

10. The system of claim 1, wherein each pair of workpieces comprises means for vertical alignment until the welding process is completed.

11. The system of claim 1, wherein each pair of welding shoes comprises copper having means using either water or air circulation for temperature control of the shoes.

12. A welding system in which at least one pair of vertically aligned workpieces are brought together so that a forty-five degree angled gap having a gap center line exists between the workpieces, the system comprising:
(a) at least one welding fixture, each fixture comprising means for releasably coupling to at least one workpiece, a pair of opposing welding shoes placed on each side of the gap to form a welding cavity between the workpieces the shoes, and means for positioning the welding shoes adjacent the cavity;
(b) at least one welding torch configured to receive at least one consumable guide tube which is placed into the welding cavity, the welding torch coupled to the welding fixture adjacent to each center line; and
(c) means for oscillating each welding torch with the cavity.

13. The system of claim 12, further comprising at least one movable portable platform to carry the wire feeders and welding-wire from building column to column, and using the wire feeder to pull wire from the wire source and push the wire down a flexible conduit assemblies to the welding torch assembly, down the consumable guide tube to the welding puddle.

14. The system of claim 12, wherein oscillating means comprises:
(a) means for longitudinally translating the linear actuators along the shafts;
(b) means for sensing movement of the linear actuators; and
(c) protective housing means for enclosing the shafts, motor, and lead screw mechanism that drive the actuator cover plate.

15. The system of claim 12, further comprising a welding wire, the welding wire including a metal core wire with metal powder chemistry in the core of the wire to form the correct chemistry for the weld to have sufficient physical strength to meet or exceed any and all of the applicable welding codes for this type of welding operation.

16. The system of claim 12, further comprising at least one flux dispenser, each flux dispenser comprising:
(a) a hopper;
(b) a rotating wheel positioned below the hopper; and
(c) at least one drop tube associated with a lower portion of the recessed area.

17. The system of claim 12, further comprising at least one welding shoe bottom clamping assembly, each clamping assembly comprising:
(a) first and second pairs of welding shoes;
(b) means for positionally adjusting the first pair of welding shoes relative to each other;
(c) means for positionally adjusting the second pair of welding shoes relative to each other; and
(d) means for positionally adjusting the first pair of welding shoes relatively to the second pair of welding shoes.

18. The system of claim 12, further comprising a distributed control system, the distributed control system comprising:
(a) a plurality of control modules, at least one of the control modules comprising an operator control module; and
(b) a bus connecting the plurality of control modules.

19. The system of claim 18, wherein the distributed control system further comprises programming means for carrying out the operations of:
(a) reading control parameter inputs from a user, the control parameters comprising welding arc voltage, welding arc current, oscillator motion, and welding wire feed rate;
(b) controlling welding arc voltage during an automated weld cycle;
(c) controlling welding arc current during the automated weld cycle;
(d) controlling oscillator motion of the welding torch during the automated weld cycle;
(e) controlling flux dispensing in response to the welding arc voltage and the welding arc current during the automated weld cycle; and
(f) controlling welding wire feed rate during the automated weld cycle.

20. The system of claim 19, wherein the distributed control system comprises an oscillator controller module, a wire feed controller module, and a welding power supply controller module.

21. The system of claim 12, wherein the welding shoes comprise a thermally and electrically insulating coating on at least one face of each welding shoe.

22. A method for electroslag welding at least two vertical metal substrates having inside and outside surfaces, the method comprising the steps of:
(a) providing a welding fixture, the welding fixture being stationary and including means for releasably coupling to at least one vertical metal substrate, the welding fixture including at least one pair of opposing welding shoes, means for symmetrically positioning the welding shoes about a center line, a welding torch, and a consumable guide tube adjacent to the center line;
(b) positioning first and second vertical metal substrates adjacent to each other, one above the other, with a gap between the first and second substrates;
(c) attaching the welding fixture to at least one of the vertical metal substrates, the welding fixture positioned with the center line located adjacent the gap between the substrates;
(d) positionally adjusting the opposing welding shoes of the welding fixture relative to the center line to define a welding cavity between the welding shoes and the substrates, the guide tube and the center line positioned within the welding cavity; and
(e) filling the weld cavity with molten metal, using the electroslag welding process, to form a weld connecting the substrates.

23. The method of claim 22, further comprising the step of feeding welding wire through the welding torch and consumable guide tube.

24. The method of claim 23, further comprising the step of oscillating the consumable guide tube and the welding wire within the weld cavity.

25. The method of claim 24, wherein the first substrate comprises a vertically aligned column having a top surface angled 45 degrees to a horizontal plane perpendicular to the first substrate alignment and the second substrate comprises a vertically aligned I-beam column having a bottom surface angled 45 degrees to a horizontal plane perpendicular to the second substrate alignment, such that the first substrate top surface and the second substrate bottom surface define the gap between the substrates.

26. The method of claim 25, further comprising the step of providing at least one welded strongback connecting the substrate inside surfaces.

27. The method of claim 26, further comprising the step of attaching a welding shoe clamping assembly to the connected substrates, the welding shoe clamping assembly comprising:
(a) first and second pairs of welding shoes;
(b) means for positionally adjusting the first pair of welding shoes relative to each other;
(c) means for positionally adjusting the second pair of welding shoes relative to each other; and
(d) means for positionally adjusting the first pair of welding shoes relatively to the second pair of welding shoes.
